(19) United States
(12) Patent Application Publication
(10) Pub. No.: US 2015/0268700 A1
(43) Pub. Date: Sep. 24, 2015

(54) Tablet Personal Computer Case with Loud Speaker

(71) Applicant: NORDIC ENTERPRISES LIMITED, Hong Kong (HK)

(72) Inventor: Petur Hannes Olafsson, Hong Kong (HK)

(73) Assignee: NORDIC ENTERPRISES LIMITED

(21) Appl. No.: 14/543,884

(22) Filed: Nov. 17, 2014

(30) Foreign Application Priority Data
Mar. 18, 2014 (HK) 14102676.1

(51) Int. Cl. G06F 1/16; H04R 1/02

(52) U.S. Cl. CPC G06F 1/1688; H04R 1/028; H04R 1/025; G06F 1/1618; H04R 2201/025; H04R 2499/11

(57) ABSTRACT

The patent application discloses a tablet personal computer case with loud speaker. The tablet personal computer case with loud speaker comprises a loud speaker shell, wherein the loud speaker shell is buckled to the front side of the tablet personal computer, and a loud speaker component in communication connection with the tablet personal computer for achieving loud speaker functions is arranged in the loud speaker shell. The tablet personal computer case with loud speaker has simple structure, is convenient to carry, can effectively protect a touch screen of the tablet personal computer, and amplify the audio and video playing volumes of the tablet personal computer.

### CROSS-REFERENCE TO RELATED APPLICATIONS

This application claims priority of Hong Kong patent application No. 14102676.1 filed on Mar. 18, 2014, the entire content of which is hereby incorporated by reference.

### TECHNICAL FIELD

The patent application relates to the field of computer product cases, and in particular to a tablet personal computer case with loud speaker.

### BACKGROUND

With the development of science and technology, a tablet personal computer is favored by more and more users since it is small, delicate and convenient to carry. The tablet personal computer takes a touch screen as a basic input device, allows the user to perform through a touch pen or digital pen without needing a traditional keyboard or mouse, portably provides people with such functions as image shooting, audio and video playing, internet surfing, large capacity storage and the like. Moreover, it is convenient to carry, and is favored by more and more people, particularly favored by outdoor enthusiasts and business people. However, the touch screen of the tablet personal computer will be damaged sometimes during carrying since it is collided with other objects, thus affecting the normal working of the tablet personal computer. Moreover, when the tablet personal computer is used to play audio and video, the sound of its loud speaker is too small, which brings influence to people to listen to the audio and video played by the tablet personal computer. At this time, people usually use a USB to connect an external loud speaker so as to amplify the sound of the audio and video played by the tablet personal computer, but the external loud speaker is not convenient to carry.

### SUMMARY

The technical problem to be solved by the patent application is to provide a tablet personal computer case with loud speaker with respect to the defects of the prior art.

To solve the technical problem, the patent application employs a technical solution as follows: a tablet personal computer case with loud speaker comprises a loud speaker shell, wherein the loud speaker shell is buckled to the front side of the tablet personal computer, and a loud speaker component in communication connection with the tablet personal computer for achieving loud speaker functions is arranged in the loud speaker shell.

Preferably, a clamping piece for buckling the loud speaker shell to the tablet personal computer is arranged on the loud speaker shell.

Preferably, the clamping piece comprises a first clamping portion and a second clamping portion. The first clamping portion and the second clamping portion are arranged in an “L” shape. The first clamping portion is arranged on the side edge of the loud speaker shell and pushes against the side edge of the tablet personal computer. The second clamping portion pushes against the back side of the tablet personal computer. The first clamping portion and the second clamping portion are matched so as to clamp and buckle the loud speaker shell to the tablet personal computer.

Preferably, the front side of the tablet personal computer is provided with a first magnetic piece. A corresponding position of the loud speaker shell is also provided with a second magnetic piece magnetically attracted with the first magnetic piece.

Preferably, a plurality of loud speaker holes are arranged on the loud speaker shell, and a foldable supporting frame matched with the loud speaker holes to form echoes is arranged on the loud speaker shell.

Preferably, the foldable supporting frame comprises an articulating piece fixed on the loud speaker shell and a tabular supporting plate rotating around the articulating piece. The supporting plate and the loud speaker holes are matched to form echoes.

Preferably, a switching mechanism for controlling a power supply of the loud speaker component to turn on and off according to the opening and closing of the foldable supporting frame is arranged on the loud speaker shell.

Preferably, the switching mechanism comprises a microswitch arranged between the loud speaker shell and the foldable supporting frame, and the microswitch is connected to the loud speaker component.

Preferably, the switching mechanism comprises a sensor unit arranged between the loud speaker shell and the foldable supporting frame, and the sensor unit is connected to the loud speaker component.

Preferably, the sensor unit comprises a photosensitive sensor, a magnetic sensor or a proximity sensor.

Compared with the prior art, the patent application has the advantages as follows: the tablet personal computer case with loud speaker provided by the patent application has simple structure and is convenient to carry; the touch screen of the tablet personal computer can be effectively protected by utilizing the loud speaker shell buckled to the plane of the tablet personal computer, so as to prevent the tablet personal computer from being collided with other objects during carrying to damage the touch screen; and the loud speaker component arranged in the loud speaker shell and in communication connection with the tablet personal computer is utilized to amplify the audio and video volume played by the tablet personal computer.

### BRIEF DESCRIPTION OF THE DRAWINGS

The patent application will be further described hereinafter with reference to the drawings and embodiments, wherein in the drawings:

FIG. 1 is a using state space diagram of a loud speaker shell in an embodiment of the patent application.

FIG. 2 is another using state space diagram of the loud speaker shell in the embodiment of the patent application.

FIG. 3 is a using state diagram of a tablet personal computer with loud speaker shell in an embodiment of the patent application.

In the drawings: 1 refers to loud speaker shell; 11 refers to clamping piece; 111 refers to first clamping portion; 112 refers to second clamping portion; 12 refers to second magnetic piece; 13 refers to loud speaker hole; 14 refers to foldable supporting frame; 141 refers to articulating piece; 142 refers to supporting plate; 15 refers to switching mechanism; and 2 refers to tablet personal computer.

### DETAILED DESCRIPTION

To understand the technical characteristics, objects and effects of the patent application more clearly, the preferred embodiments of the patent application are described in details now with reference to the drawings.

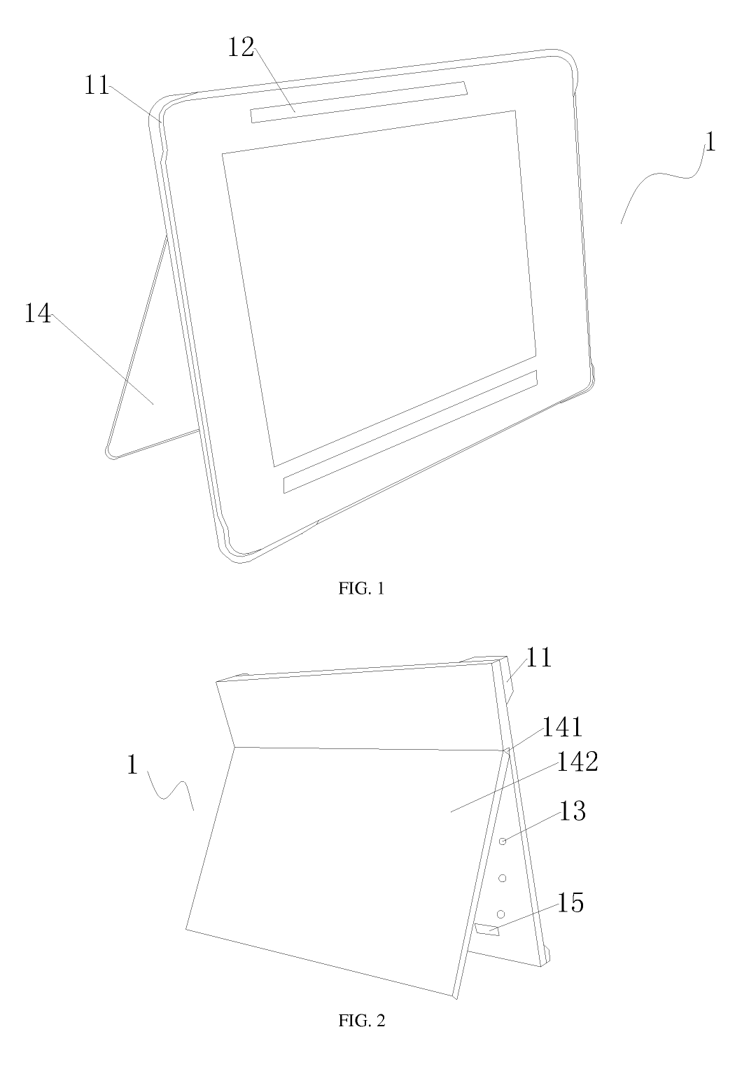

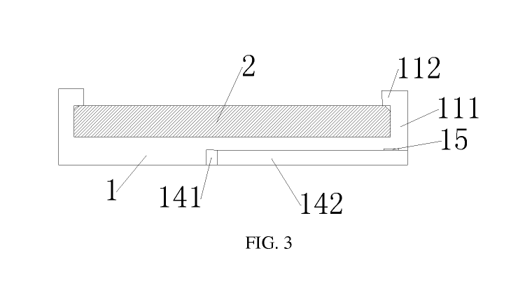

FIG. 1 shows a tablet personal computer case with loud speaker in an embodiment of the patent application. The tablet personal computer case with loud speaker comprises a loud speaker shell 1, wherein the loud speaker shell 1 is buckled to the front side of the tablet personal computer 2, which can effectively protect a touch screen of the tablet personal computer 2 so as to prevent the tablet personal computer 2 from being collided with other objects during carrying to damage the touch screen. A loud speaker component (not shown in the figure) in communication connection with the tablet personal computer 2 for achieving loud speaker functions is arranged in the loud speaker shell 1 so as to amplify the audio and video volume played by the tablet personal computer 2. It is understood that the loud speaker component in the loud speaker shell 1 is connected with the tablet personal computer 2 through wireless communication like blue tooth, Wi-Fi and the like.

In the embodiment, the tablet personal computer case with loud speaker is buckled to the front side of the tablet personal computer 2 during the process of carrying the tablet personal computer 2 so as to achieve the object of protecting the touch screen of the tablet personal computer 2. When the tablet personal computer 2 is working, the tablet personal computer case with loud speaker is used as an independent loud speaker, and amplifies the audio and video volume played by the tablet personal computer 2 through communication connection with the tablet personal computer 2.

Specifically, a clamping piece 11 for buckling the loud speaker shell 1 to the tablet personal computer 2 is arranged on the loud speaker shell 1. The clamping piece 11 comprises a first clamping portion 111 and a second clamping portion 112. The first clamping portion 111 and the second clamping portion 112 are arranged in “L” shape. The first clamping portion 111 is arranged on the side edge of the loud speaker shell 1 and pushes against the side edge of the tablet personal computer 2 for preventing the tablet personal computer 2 from falling off from the side edge of the loud speaker shell 1. The second clamping portion 112 pushes against the back side of the tablet personal computer 2 for preventing the tablet personal computer 2 from falling off from the back side of the tablet personal computer. The first clamping portion 111 and the second clamping portion 112 are matched so as to clamp and buckle the loud speaker shell 1 to the tablet personal computer 2, thus preventing the tablet personal computer 2 from falling off from the loud speaker shell 1.

To further prevent the tablet personal computer 2 from falling off from the loud speaker shell 1 during carrying, the periphery of the front side of the tablet personal computer 2 is provided with a first magnetic piece (not shown in the figure); and a corresponding position of the loud speaker shell 1 is also provided with a second magnetic piece 12 magnetically attracted with the first magnetic piece. It is understood that the first magnetic piece may be made of a magnetic material (for example, magnet). Accordingly, the second magnetic piece 12 is made of a metallic material (for example, iron, cobalt, nickel and alloy thereof) matched with the magnetic material. The magnetism effect of the magnetic material and the metallic material is utilized to fix the tablet personal computer 2 on the loud speaker shell 1, vice versa.

To better achieve the loud speaker function, a plurality of loud speaker holes 13 are arranged on the loud speaker shell 1 to generate acoustic vibration when the loud speaker component is working, so that air just behind the loud speaker shell 1 needs to move. The plurality of loud speaker holes 13 arranged on the loud speaker shell 1 can make the air just behind the loud speaker shell 1 pass through so as to ensure an excellent frequency range when the loud speaker component is working, and thus ensuring the effect of the loud speaker. A foldable supporting frame 14 matched with the loud speaker holes 13 to form echoes is arranged on the loud speaker shell 1. Specifically, the foldable supporting frame 14 comprises an articulating piece 141 fixed on the loud speaker shell 1 and a tabular supporting plate 142 rotating around the articulating piece 141. When the tabular supporting plate 142 is closed, the air in the loud speaker holes 13 on the loud speaker shell 1 cannot pass through smoothly, so that the loud speaking effect is poor and the frequency range will be reduced. When the supporting plate is opened, a gap exists between the supporting plate 142 and the loud speaker holes 13, which enables the air in the loud speaker holes 13 to pass through and also enables the air just behind the loud speaker shell 1 to flow between the loud speaker shell 1 and the supporting plate 142 at the same time to form echoes, thus enabling the sound amplified by the loud speaker component to have better sound effect.

In view that the opening and closing of the foldable supporting frame 14 on the loud speaker shell 1 can effectively control the sound effect of the loud speaker component, a switching mechanism 15 for controlling a power supply of the loud speaker component to turn on and off according to the opening and closing of the foldable supporting frame 14 is arranged on the loud speaker shell 1. The switching mechanism 15 can turn on a power supply switch of the loud speaker component when the foldable supporting frame 14 is opened to make the loud speaker component work normally, and turn off the power supply switch of the loud speaker component when the foldable supporting frame 14 is closed to disable the loud speaker component.

Specifically, the switching mechanism 15 comprises a microswitch arranged between the loud speaker shell 1 and the foldable supporting frame 14, and the microswitch is connected to the loud speaker component. It is understood that the microswitch can be arranged on the articulating piece 14 or other position that can sense the rotation of the supporting plate 142 of the foldable supporting frame 14 around the articulating piece 141. When the supporting plate 142 is opened by rotating around the articulating piece 141, the state of the microswitch is changed and the power supply switch of the loud speaker component is turned on. When the supporting plate 142 is closed by rotating around the articulating piece 141, the state of the microswitch is changed and the power supply switch of the loud speaker component is turned off.

The switching mechanism 15 comprises a sensor unit (not shown in the figure) arranged between the loud speaker shell 1 and the foldable supporting frame 14, and the sensor unit is connected to the loud speaker component. It is understood that the sensor unit comprises a photosensitive sensor, a magnetic sensor or a proximity sensor. Taking the photosensitive sensor for example, when the supporting plate 142 is opened by rotating around the articulating piece 141, the photosensitive sensor senses that light brightens, and then turns on the power supply switch of the loud speaker component. When the supporting plate 142 is closed by rotating around the articulating piece 141, the photosensitive sensor senses that the light darkens, and controls to turn off the power supply switch of the loud speaker component.

The patent application is illustrated through several specific embodiments. Those skilled in the art should understand that various transformation and equivalent substitutions can be made on the patent application in the case of without departing from the scope of the patent application. Moreover, with respect to specific situations or specific conditions, various modifications can be made on the patent application without departing from the range of the patent application. Therefore, the patent application is not limited to the specific embodiments disclosed, but shall include all the embodiments that fall within the scope of the claims of the patent application.

1. A tablet personal computer case with loud speaker, comprising: a loud speaker shell (1), wherein the loud speaker shell (1) is buckled to the front side of the tablet personal computer (2), and a loud speaker component in communication connection with the tablet personal computer (2) for achieving loud speaker functions is arranged in the loud speaker shell (1).

2. The tablet personal computer case with loud speaker according to claim 1, wherein a clamping piece (11) for buckling the loud speaker shell (1) to the tablet personal computer (2) is arranged on the loud speaker shell (1).

3. The tablet personal computer case with loud speaker according to claim 2, wherein the clamping piece (11) comprises a first clamping portion (111) and a second clamping portion (112); the first clamping portion (111) and the second clamping portion (112) are arranged in an “L” shape; the first clamping portion (111) is arranged on the side edge of the loud speaker shell (1) and pushes against the side edge of the tablet personal computer (2); the second clamping portion (112) pushes against the back side of the tablet personal computer (2); the first clamping portion (111) and the second clamping portion (112) are matched so as to clamp and buckle the loud speaker shell (1) to the tablet personal computer (2).

4. The tablet personal computer case with loud speaker according to claim 1, wherein the front side of the tablet personal computer (2) is provided with a first magnetic piece; and a corresponding position of the loud speaker shell (1) is also provided with a second magnetic piece (12) magnetically attracted with the first magnetic piece.

5. The tablet personal computer case with loud speaker according to claim 1, wherein a plurality of loud speaker holes (13) are arranged on the loud speaker shell (1), and a foldable supporting frame (14) matched with the loud speaker holes (13) to form echoes is arranged on the loud speaker shell (1).

6. The tablet personal computer case with loud speaker according to claim 5, wherein the foldable supporting frame (14) comprises an articulating piece (141) fixed on the loud speaker shell (1) and a tabular supporting plate (142) rotating around the articulating piece (141); the supporting plate (142) and the loud speaker holes (13) are matched to form echoes.

7. The tablet personal computer case with loud speaker according to claim 5, wherein a switching mechanism (15) for controlling a power supply of the loud speaker component to turn on and off according to the opening and closing of the foldable supporting frame (14) is arranged on the loud speaker shell (1).

8. The tablet personal computer case with loud speaker according to claim 5, wherein the switching mechanism (15) comprises a microswitch arranged between the loud speaker shell (1) and the foldable supporting frame (14), and the microswitch is connected to the loud speaker component.

9. The tablet personal computer case with loud speaker according to claim 5, wherein the switching mechanism (15) comprises a sensor unit arranged between the loud speaker shell (1) and the foldable supporting frame (14), and the sensor unit is connected to the loud speaker component.

10. The tablet personal computer case with loud speaker according to claim 9, wherein the sensor unit comprises a photosensitive sensor, a magnetic sensor or a proximity sensor.
